(19) United States
(12) Patent Application Publication
(10) Pub. No.: US 2021/0065072 A1
(43) Pub. Date: Mar. 4, 2021

(54) VEHICLE, OPERATION MANAGEMENT SYSTEM, OPERATION MANAGEMENT METHOD, AND INFORMATION PROCESSING APPARATUS

(71) Applicant: TOYOTA JIDOSHA KABUSHIKI KAISHA, Toyota-shi (JP)

(72) Inventors: Yuki TATSUMOTO, Nagoya-shi (JP); Saori MATSUMOTO, Chofu-shi (JP); Keigo YAMADA, Toyota-shi (JP); Akira SASAKI, Miyoshi-shi (JP); Mitsuhiro MIURA, Toyota-shi (JP)

(73) Assignee: TOYOTA JIDOSHA KABUSHIKI KAISHA, Toyota-shi (JP)

(21) Appl. No.: 17/003,302

(22) Filed: Aug. 26, 2020

(30) Foreign Application Priority Data
Aug. 30, 2019 (JP) 2019-158735

(51) Int. Cl. G06Q 10/02; G07C 9/00; H04W 4/021; H04W 4/40

(52) U.S. Cl. CPC G06Q 10/02; G07C 9/00896; G07C 2009/0092; H04W 4/40; H04W 4/021

(57) ABSTRACT

A vehicle includes: a compartment equipped with a locker configured to be usable by a user and a communication apparatus communicably connected with a terminal apparatus possessed by the user and configured to acquire point-of-use information from the terminal apparatus, the point-of-use information concerning a point at which the user uses the locker, wherein the vehicle moves based on the point-of-use information.

### CROSS-REFERENCE TO RELATED APPLICATIONS

The present application claims priority to Japanese patent application No. 2019-158735 filed on Aug. 30, 2019, the entire disclosure of which is incorporated herein by reference.

### TECHNICAL FIELD

The present disclosure relates to a vehicle, an operation management system, an operation management method, and an information processing apparatus.

### BACKGROUND

Conventionally, systems that manages coin lockers are known. For example, JP 2002-259545A (PTL 1) discloses a method for reserving a coin locker via a portable terminal.

### CITATION LIST

### Patent Literature

PTL 1: JP2002259545A

### SUMMARY

In order to use a locker, it is necessary for a user to move to a place where a locker is installed. There is demand for improved user convenience.

An object of the present disclosure made in view of the above circumstances is to improve user convenience.

A vehicle according to an embodiment of the present disclosure comprises: a compartment equipped with a locker configured to be usable by a user; and a communication apparatus configured to communicably connect with a terminal apparatus possessed by the user and acquire point-of-use information from the terminal apparatus, the point-of-use information concerning a point at which the user uses the locker, wherein the vehicle is configured to move based on the point-of-use information.

An operation management system according to an embodiment of the present disclosure comprises: the vehicle; and the terminal apparatus possessed by the user, wherein the terminal apparatus outputs the point-of-use information.

An operation management method according to an embodiment of the present disclosure comprises steps in which: a vehicle carrying a locker usable by a user and configured to be movable acquires point-of-use information about a point at which the user uses the locker; and the vehicle moves based on the point-of-use information.

An information processing apparatus according to an embodiment of the present disclosure comprises: a communication interface configured to communicably connect with a vehicle and with a terminal apparatus possessed by a user, the vehicle carrying a locker configured to be usable by the user; and a controller configured to output control information used to control running of the vehicle, wherein the communication interface is configured to acquire point-of-use information from the terminal apparatus, the point-of-use information concerning a point at which the user uses the locker, and the controller is configured to generate the control information based on the point-of-use information and outputs the control information to the vehicle through the communication interface.

The vehicle, the operation management system, the operation management method, and the information processing apparatus according to an embodiment of the present disclosure can improve user convenience.

### BRIEF DESCRIPTION OF THE DRAWINGS

In the accompanying drawings:

FIG. 1 is a schematic diagram illustrating a configuration example of an operation management system according to an embodiment;

FIG. 2 is a block diagram illustrating the configuration example of the operation management system according to the embodiment;

FIG. 3 is a side view illustrating a configuration example of the vehicle; and

FIG. 4 is a flowchart illustrating an example of procedures carried out by a server.

### DETAILED DESCRIPTION

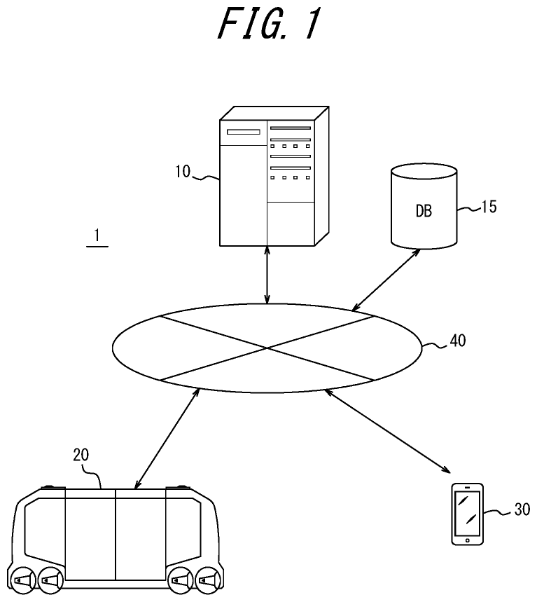

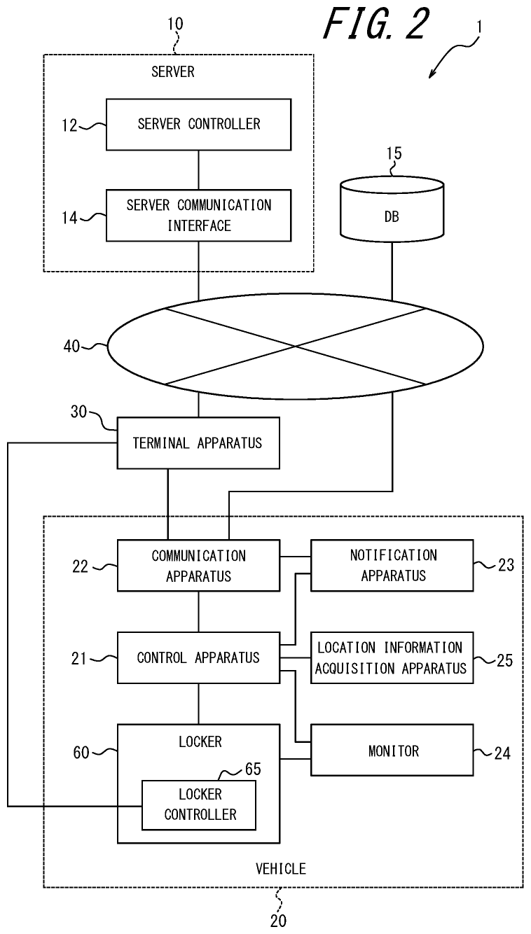

As illustrated in FIGS. 1 and 2, an operation management system 1 according to an embodiment includes a server 10, a vehicle 20, and a terminal apparatus 30. The operation management system 1 further includes a database (DB) 15, which, however, is not essential. The server 10, the vehicle 20, the terminal apparatus 30, and the DB 15 are connected to a network 40, and are able to communicate with one another. The server 10, the vehicle 20, the terminal apparatus 30, and the DBs 15 are not limited to one in number, and may be two or more.

The vehicle 20 carries a locker 60 usable by a user. The use of the locker 60 by the user includes storing items in the locker 60 and retrieving items from the locker 60. When the user desires to use a locker 60, the operation management system 1 prepares a vehicle 20 carrying a locker 60 based on a request for use from the user. The operation management system 1 manages operation of the vehicle 20 so as to move the vehicle 20 to a destination, which is set to a point at which the user uses the locker 60. The user possesses the terminal apparatus 30 and requests the use of a locker 60 by accessing the server 10 from the terminal apparatus 30. The server 10 accepts the request for use from the user. Based on the request for use from the user, the server 10 prepares a vehicle 20 carrying a locker 60 to be used by the user. The server 10 may control an operation route or an operation schedule of the vehicle 20 carrying the locker 60 to be used by the user. The server 10 may determine whether the request for locker use from the user can be accepted, based on an operation status of the vehicle 20. The server 10 may determine operation route or operation schedule of the vehicle 20, based on results of accepting the request from the user. The service that involves operating a vehicle 20 based on a request for use from the user, allowing the user to use a locker 60 is also referred to as an on-demand locker service. The operation management system 1 can provide the on-demand locker service.

The server 10 may include one server apparatus or plural server apparatuses capable of communicating with one another. The server 10 is also referred to as an information processing apparatus. The server 10 may be operated, for example, by the supplier of the on-demand locker service. The server 10 accepts the request for use of a locker 60 from the user and manages the usage status of the locker 60. The server 10 may exchange various information about the on-demand locker service with the vehicle 20. In addition to these processes, the server 10 may be configured to perform various other processes related to the on-demand locker service. The server 10 manages the operation of the vehicle 20. By communicating with the vehicle 20, the server 10 may acquire, for example, various information about the vehicle 20, including the position and speed of the vehicle 20. In addition to these processes, the server 10 may be configured to perform various other processes needed to manage the operation of the vehicle 20.

The server 10 includes a server controller 12 and a server communication interface 14. The server controller 12 is also referred to simply as a controller. The server controller 12 may include one or more processors. According to the present embodiment, the “processor” is a general-purpose processor, a dedicated processor specializing in a specific process, or another processor, but this is not restrictive. The server controller 12 may include one or more dedicated circuits. The dedicated circuit may include, for example, an FPGA (Field-Programmable Gate Array) or an ASIC (Application Specific Integrated Circuit). The server controller 12 may include a dedicated circuit instead of, or in addition to, the processors.

The server communication interface 14 is also referred to simply as a communication interface. The server communication interface 14 may include a communication module and communicate with the vehicle 20. The server 10 may further include a memory. The memory may be, for example, a semiconductor memory, a magnetic memory, or an optical memory, but is not limited to these. The memory may function, for example, as a main memory, an auxiliary memory, or a cache memory. The memory may include an electromagnetic storage medium such as a magnetic disk. The memory may include a non-transitory computer-readable medium. The memory may store any information used for operation of the server 10. For example, the memory may store system programs, application programs, or the like. The server 10 may store programs, information, or the like using the DB 15 as a memory. The memory may be included in the server controller 12.

The vehicle 20 includes a control apparatus 21, a communication apparatus 22, and a monitoring unit 24. The control apparatus 21, the communication apparatus 22, and the monitoring unit 24 are connected in such a way as to be able to communicate with one another, for example, via an in-vehicle network such as a CAN (Controller Area Network) or via a dedicated line.

The control apparatus 21 controls components of the vehicle 20. The control apparatus 21 may include one or more processors. The control apparatus 21 may include one or more dedicated circuits instead of, or in addition to, the processors. The control apparatus 21 may further include a memory.

The communication apparatus 22 communicates with the server 10 via the network 40. The communication apparatus 22 may communicate with the terminal apparatus 30 via the network 40, or without going via the network 40. The communication apparatus 22 may be, for example, an in-vehicle communication device. The communication apparatus 22 may include a communication module for connecting to the network 40. The communication module may include, for example, a communication module compatible with the 4G (4th Generation) standard, the 5G (5th Generation) standard, or other mobile communication standards, but is not limited to these.

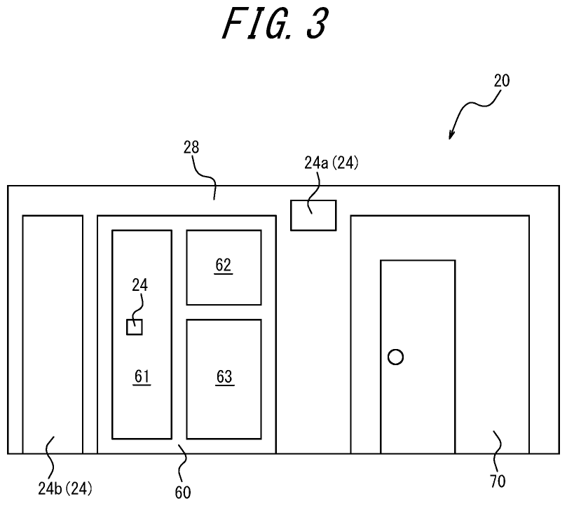

The monitoring unit 24 may include a camera 24a (see FIG. 3). The camera 24a photographs persons or objects existing around the vehicle 20. The camera 24a may include an image sensing device configured to sense visible light or an image sensing device configured to sense electromagnetic waves, such as infrared light, other than visible light. The vehicle 20 may transmit images taken by the camera 24a to the server 10 via the communication apparatus 22.

As described above, the vehicle 20 further includes the locker 60. The locker 60 may include a locker controller 65 configured to control locking and unlocking of the locker 60 or the like although the locker controller 65 is not essential.

Although not essential, the vehicle 20 may further include a location information acquisition apparatus 25. The location information acquisition apparatus 25 is connected with other components mounted on the vehicle 20 in such a way as to be able to mutually communicate via an in-vehicle network such as a CAN or via a dedicated line. The location information acquisition apparatus 25 acquires location information about the vehicle 20. The location information acquisition apparatus 25 may include a receiver compatible with a satellite positioning system. The receiver compatible with a satellite positioning system may include, for example, a GPS (Global Positioning System) receiver. According to the present embodiment, it is assumed that the vehicle 20 can acquire location information about the vehicle 20 itself using the location information acquisition apparatus 25. The vehicle 20 may output the location information about the vehicle 20 itself to the server 10 or the terminal apparatus 30.

The vehicle 20 is configured to move to the point at which the user uses the locker 60. The vehicle 20 may be configured to be driven by a driver. The vehicle 20 may be configured to be operable by self-driving. The self-driving may be carried out, for example, at any of level 1 to level 5 defined by the SAE (Society of Automotive Engineers). The self-driving may be carried out based on not only the cited definition, but also another definition.

When the vehicle 20 is controlled by self-driving, the control apparatus 21 controls running of the vehicle 20. The server 10 outputs control information including information that identifies the destination of the vehicle 20 to the vehicle 20. The control apparatus 21 controls running of the vehicle 20 based on the control information outputted from the server 10 and moves the vehicle 20 to the destination.

Although not essential, the vehicle 20 may further include a notification apparatus 23, which, however, is not essential. The notification apparatus 23 is connected with other components mounted on the vehicle 20 in such a way as to be able to mutually communicate via an in-vehicle network such as a CAN or via a dedicated line. The notification apparatus 23 provides information to the driver of the vehicle 20.

The notification apparatus 23 may provide information to the driver as visual information such as an image, characters, graphics, or the like. In that case, the notification apparatus 23 may comprise a display device. The display device may include a light emission device such as an LED (Light Emission Diode). The display device may be, for example, a liquid crystal display (LCD). The display device may be an organic EL (Electro-Luminescent) display or an inorganic EL display. The display device may be a plasma display panel (PDP). The display device is not limited to these displays and may be any of various other types of display.

The notification apparatus 23 may provide information to the driver as audio information such as voice. In that case, the notification apparatus 23 may be made up of a device, such as a speaker, that outputs voice. The notification apparatus 23 is not limited to these devices, and may be made up of any of various other types of device.

The vehicle 20 may be driven by the driver rather than self-driving. In that case, the notification apparatus 23 may acquire information that identifies the destination of the vehicle 20 from the server 10 and inform the driver about the destination of the vehicle 20. The driver drives and moves the vehicle 20 to the destination informed by the notification apparatus 23.

The terminal apparatus 30 communicates with the vehicle 20 either via the network 40, or without going via the network 40. The terminal apparatus 30 communicates with the server 10 via the network 40. The terminal apparatus 30 may include a portable terminal such as a smart phone.

The terminal apparatus 30 may run an application program used by the user to request the use of a locker 60. The terminal apparatus 30 may communicate with the server 10 to exchange information related to the user's request for the use of a locker 60. The information related to the user's request for the use of a locker 60 is also referred to as usage request information. The terminal apparatus 30 may allow the user to enter the usage request information via the application program.

The terminal apparatus 30 may be configured to communicate directly with the locker controller 65 by NFC (Near Field Communication), infrared communication, or the like.

The terminal apparatus 30 may acquire location information about the terminal apparatus 30 itself for example, by being equipped with a component the same as or similar to the location information acquisition apparatus 25 of the vehicle 20. The terminal apparatus 30 may output the location information about the terminal apparatus 30 itself to the server 10 or the vehicle 20.

As illustrated in FIG. 3, the vehicle 20 includes a compartment 28. The locker 60 is installed in the compartment 28. The compartment 28 includes a space needed by the user for storing items in the locker 60 and retrieving items from the locker 60. The number of lockers 60 installed in the compartment 28 is not limited to one, and may be two or more.

The locker 60 includes a storage space configured to store items having a size equal to or smaller than a predetermined size. The storage space of the locker 60 may be divided into plural partitions. In the example of FIG. 3, the storage space of the locker 60 is divided into a first partition 61, a second partition 62, and a third partition 63. The sizes of the items storable in the locker 60 can be determined based on the shape and size of each partition. The sizes of the items storable in the locker 60 can be determined based further on the size of an opening through which the items are put into and taken out of each partition. The size of each item may be identified by the height, the width, and the depth of the item. The first partition 61 is configured to be vertically elongated such that, for example, clothes hung on hangers can be stored. The second partition 62 is configured to store small items. The third partition 63 is configured to store items larger than those in the second partition 62.

The storage space may be provided with a door configured to be openable and closable as well as lockable. When the door is unlocked and open, the user can put items into and take items out of the storage space. When the door of the storage space is closed and locked, the items stored in the storage space are protected. The locking and unlocking of the door of the locker 60 may be controlled by the control apparatus 21. If the locker 60 is provided with the locker controller 65, the locking and unlocking of the door of the locker 60 may be controlled by the locker controller 65. The control apparatus 21 may output control information, instructing the locker controller 65 to lock and unlock the door. The control apparatus 21 or locker controller 65 may receive a command to lock and unlock the door from the terminal apparatus 30 possessed by the user. By communicating directly with the locker controller 65, the terminal apparatus 30 may output control information, instructing the locker controller 65 to lock and unlock the door. The locker controller 65 may acquire information about a locked state of the door or information about an open/closed state of the door and output the information to the server 10.

The server controller 12 acquires information about the state of each partition via the control apparatus 21 or locker controller 65. The state of each partition can be either a state of storing an item or a vacant state. The partition in a state of storing an item is also referred to as an occupied partition. The partition in a vacant state is also referred to as an unoccupied partition. The server controller 12 determines whether to accept a request for use of a locker 60 from the user based on the state of each partition. A method for the server controller 12 to determine whether to accept a request for use from the user will be described later. When accepting a request for use, the server controller 12 allocates a partition to be used to the user. The state of the allocated partition is a reserved state. The partition in a reserved state is also referred to as a reserved partition. The reserved partition can be regarded as an occupied partition.

The locker 60 may further include a sensor configured to detect items existing in the partitions. The sensor may include a proximity sensor. The locker controller 65 may acquire a state of the partitions based on detection results from the sensor.

Accepting a Request for Use

The server controller 12 acquires information about the point at which the user uses the locker 60 as usage request information. The point at which the user uses the locker 60 is also referred to as a point of use. The information about the point at which the user uses the locker 60 is also referred to as point-of-use information. Based on the point-of-use information, the server controller 12 selects a vehicle 20 that can run to the point of use. The server controller 12 outputs the point-of-use information to the selected vehicle 20. Based on the point-of-use information, the vehicle 20 runs to the destination, which is set to the point of use.

The point of use may be specified, for example, by an address or by a latitude and longitude. When the point of use is specified with pinpoint accuracy or specified in a narrow range, the number of vehicles 20 that satisfy conditions may be reduced. The point of use may be specified by information indicating a range permissible as the point at which the user actually uses the locker 60. For example, the point-of-use information may include information indicating a permissible distance by which the point at which the user actually uses the locker 60 can be separated from the point of use specified by the user. Specifically, a distance permissible for the user may be specified as a distance from the point of use specified by the user to the point at which the locker 60 is actually used.

The point of use may be specified by information indicating a predetermined range. The predetermined range may be specified, for example, by an address. The predetermined range may be specified by boundaries that identify the range. The boundaries may be specified as lines connecting plural points. The predetermined range may be specified as a range along a predetermined path.

The server controller 12 may further acquire information about the time at which the user uses the locker 60 as usage request information. The time at which the user uses the locker 60 is also referred to as usage time. The information about the time at which the user uses the locker 60 is also referred to as usage time information. The server controller 12 selects a vehicle 20 that can run to the point of use by the time identified by the usage time information. The server controller 12 outputs the point-of-use information and usage time information to the vehicle 20. The vehicle 20 runs so as to arrive at the point of use at the usage time.

The usage time may be specified as a specific time. When the usage time is specified with pinpoint accuracy or specified in a narrow range, the number of vehicles 20 that satisfy conditions may be reduced. The usage time may be specified by information indicating a range permissible as the time at which the user actually uses the locker 60. For example, the usage time information may include information indicating a permissible length of time by which the time at which the user actually uses the locker 60 can be earlier or later than the time specified by the user. Specifically, a permissible range for the user may be specified for the usage time specified by the user.

The usage time may be specified as a predetermined time slot. The predetermined time slot may be identified as a time slot between the earliest time and latest time permissible for the user.

The server controller 12 may select a vehicle 20 scheduled to operate on a route passing through the point of use specified by the user. The server controller 12 may select a vehicle 20 scheduled to operate on a route passing through the point of use at the usage time specified by the user. When allowing the user to use the locker 60 carried by the selected vehicle 20, the server controller 12 specifies the point of use and the usage time.

When the user is to store an item in the locker 60, the server controller 12 may further acquire information about the item as usage request information. The information about the item is also referred to as item information. The server controller 12 selects a vehicle 20 carrying a locker 60 capable of storing the item identified by the item information. The server controller 12 outputs the point-of-use information to the selected vehicle 20. The selected vehicle 20 runs to the destination, which is set to the point of use, based on the point-of-use information.

The item information includes information about the size of the item. When the size of the item is equal to or smaller than a predetermined item size storable in the locker 60, the server controller 12 may select the vehicle 20 carrying the locker 60. The selected vehicle 20 runs to the destination, which is set to the point of use, based on the point-of-use information. That is, when the size of the item to be stored in the locker 60 by the user is equal to or smaller than a predetermined size, the selected vehicle 20 moves based on the point-of-use information.

The usage request information includes information identifying whether the user is using the locker 60 to store an item in the locker 60 or to retrieve an item from the locker 60. Operations performed by the server controller 12 when the user is storing an item in the locker 60 and when the user is retrieving an item from the locker 60, respectively, will be described below.

Storing an Item

When the user is going to store an item in the locker 60, the server controller 12 determines whether there is a vehicle 20 that satisfies the conditions specified by the usage request information. The server controller 12 may determine whether there is at least a vehicle 20 that can move to the point of use. When there is a vehicle 20 that satisfies the conditions specified by the usage request information, the server controller 12 determines to accept the request for locker use. The server controller 12 selects the vehicle 20 carrying the locker 60 to be used by the user from among the vehicles 20 that satisfy the conditions. The server controller 12 may select, for example, a vehicle 20 that can move to a point closest to the point of use specified by the user or select a vehicle 20 that can move to the point of use by a time closest to the usage time specified by the user. When the vehicle 20 carries two or more lockers 60, the server controller 12 may further select a locker 60 to be used by the user. The server controller 12 controls the running of the selected vehicle 20 to the destination, which is set to the point of use, such that the user can use the locker 60. The server controller 12 may determine a partition of the locker 60 to be used by the user. The server controller 12 may manage the number of vacant partitions out of the partitions of the locker 60 to be used by the user, and allow the user to select a partition at the time that the user uses the locker 60.

The server controller 12 notifies the terminal apparatus 30 possessed by the user about the destination and estimated time of arrival of the vehicle 20 carrying the locker 60 to be used by the user. The user can move to the destination of the vehicle 20, i.e., the point of use of the locker 60, based on the provided information, and thereby use the locker 60 to store an item in the locker 60 carried by the vehicle 20.

The user stores the item in a predetermined partition of the locker 60 carried by the vehicle 20 that has come the point of use. The predetermined partition may be either specified by the server controller 12 or selected by the user. The server controller 12 may associate the partition storing the item with information identifying the stored item. The information identifying the stored item may include, for example, a reference number or user ID. The server controller 12 recognizes the state of the partition storing the item as a state of storing an item.

Retrieving an Item

When the user is going to retrieve an item from the locker 60, the server controller 12 identifies the locker 60 storing the item to be retrieved by the user. The server controller 12 identifies the locker 60 associated with the item, based on the information included in the usage request information and identifying the item stored in the locker 60. The server controller 12 outputs the point-of-use information that is based on the usage request information to the vehicle 20 carrying the identified locker 60 such that the user can retrieve the item. The vehicle 20 runs to the destination, which is set to the point of use, based on the point-of-use information.

The server controller 12 notifies the terminal apparatus 30 possessed by the user about the destination and estimated time of arrival of the vehicle 20 carrying the locker 60 to be used by the user. The user can move to the destination of the vehicle 20, i.e., the point of use of the locker 60, based on the provided information, and thereby use the locker 60 to retrieve the item from the locker 60 carried by the vehicle 20.

The user retrieves the item from the locker 60 carried by the vehicle 20 that has come the destination. The server controller 12 recognizes the state of the partition from which the item has been retrieved as a vacant state.

The user may retrieve only some items, leaving the remaining items in the locker 60. The user may further store other items in the locker 60 in addition to the items already stored. In these cases, the server controller 12 recognizes the state of the partition used by the user as a state in which items remain stored.

The server controller 12 may accept a request from a user wanting to retrieve an item from the locker 60 preferentially over a request from a user wanting to store an item in the locker 60. When there is a request to retrieve an item from the locker 60 carried by a vehicle 20, the server controller 12 may control the running of the vehicle 20 such that the user can retrieve the item regardless of the running state of the vehicle 20. For example, even when running a vehicle 20 to a destination based on a request to store an item, if a request to retrieve an item is accepted, the server controller 12 may change the destination of the vehicle 20 such that the user can retrieve the item.

When plural requests to retrieve items from a locker 60 carried by a single vehicle 20 are accepted, the server controller 12 may control the running of the vehicle 20 by giving priority to a request accepted earlier. The server controller 12 may control the running of the vehicle 20 so as to satisfy as many as possible of the conditions contained in the usage request information of the requests.

The point of use at which an item is retrieved from a locker 60 may be different from the point at which the item was stored in the locker 60. This makes it easy for the user to retrieve items. Consequently, user convenience is improved.

Usage Confirmation and Billing Process

After moving the vehicle 20 to the point of use, the server controller 12 may check whether the user is using the locker 60. From the locker controller 65, the server controller 12 may acquire a door open/close history of the partition to be used by the user or acquire information indicating whether an item is stored in the partition to be used by the user.

After the vehicle 20 arrives at the point of use, if there is a new entry in the door open/close history of the partition to be used by the user, the server controller 12 may determine that the user has used the locker 60. If the user's purpose for use is to store an item, the server controller 12 may determine that the user is using the locker 60 on condition that there is an item in the partition for use by the user. If the user's purpose for use is to retrieve an item, the server controller 12 may determine that the user has used the locker 60 on condition that there is no item in the partition for use by the user.

After the vehicle 20 arrives at the point of use and a specified usage time arrives, if it cannot be determined that the user has used the locker 60 within a predetermined time frame, the server controller 12 may determine that the user has not used the locker 60. The server controller 12 may either automatically treat the user's locker usage request as having been cancelled or output a notice to the user's terminal apparatus 30, asking the user whether to cancel the request for the use of the locker 60.

If the user uses a locker 60, the server controller 12 may impose a usage charge on the user. If the user cancels the request for the use of the locker 60, the server controller 12 may impose a cancellation charge on the user. The terminal apparatus 30 may allow the user to enter, in advance, a means of paying usage charges, cancellation charges, or other charges. The server controller 12 may acquire information about the means of paying charges from the terminal apparatus 30 and output information needed to pay charges, to the terminal apparatus 30. The means of paying charges may include account transfer payment, credit card payment, or electronic money payment. The means of paying charges may include payment based on points exchangeable with valuables or paid services. The means of paying charges are not limited to these examples and may include various other means.

When the user uses a locker 60, the server controller 12 may calculate the usage charge and bill the user based on the length of time for which the partition used by the user remains an occupied partition. The server controller 12 may calculate the usage charge and bill the user based further on the length of time for which the partition used by the user remains a reserved partition.

If the user cancels a request to store an item in a locker 60, the server controller 12 may calculate the cancellation charge and bill the user based on the length of time for which the partition for use by the user remains a reserved partition. The server controller 12 may accept locker usage requests by giving a lower priority to a locker usage request from a user who has cancelled a locker usage request before than to a locker usage request from a user who has never cancelled a locker usage request.

When an item is stored in the locker 60 by the user, the server controller 12 may calculate a storage period. If the user leaves an item without retrieval until the storage period exceeds a predetermined period, the server controller 12 may output a notice to the terminal apparatus 30 of the user, prompting the user to retrieve the item. The server controller 12 may judge that the user has no intention to retrieve the item, and output information instructing that the item be retrieved from the partition used by the user. If the user leaves the item until the storage period exceeds the predetermined period, the server controller 12 may not only impose a usage charge based on the length of time for which the partition used by the user remains an occupied partition, but also further impose a penalty charge. The server controller 12 may estimate a duration of use by the user based on the usage request information at the time that user stores an item in the locker 60, impose the usage charge as advance payment based on the estimated duration of use, and bill the user.

As has been described above, the operation management system 1 according to the present embodiment can provide an on-demand locker service to the user. This improves the convenience for the user who uses the locker 60.

Other Configurations

Using a Private Cubicle

As illustrated in FIG. 3, the compartment 28 may include a private cubicle 70. The private cubicle 70 may be configured for use as a changing room for the user. The private cubicle 70 may be provided with facilities such as a shower or massage chair available for use by the user. In using the locker 60, by using the private cubicle 70 as a changing room, the user can change into sportswear and store spare clothes in the locker 60. This makes it easy for the user to do physical exercise such as running, walking, or gymnastic exercise on a nearby road or in a nearby park using the vehicle 20 as a base. Consequently, user convenience is improved.

The use of the private cubicle 70 may be limited to when the locker 60 is used. The vehicle 20 may be configured to run with the user remaining in the private cubicle 70. The private cubicle 70 may be provided with a door configured to be lockable. The locking and unlocking of the private cubicle 70 may be controlled by control information from the control apparatus 21 or terminal apparatus 30. When the user uses the private cubicle 70, the server controller 12 may impose an extra usage charge for the private cubicle 70 in addition to the usage charge for the locker 60.

Automatic Requests

For example, the terminal apparatus 30 of the user may acquire biomedical information on the user such as heart rate or blood pressure. Based on the biomedical information on the user, the terminal apparatus 30 may propose a timing for finishing physical exercise to the user. The terminal apparatus 30 may determine the point of use and usage time of the locker 60, timed with the finish of the user's physical exercise. The terminal apparatus 30 may generate usage request information including the determined point of use and usage time and output the usage request information to the server 10. That is, the terminal apparatus 30 may request the use of the locker 60 automatically. This allows the user to use the locker 60 with appropriate timing without entering information. Consequently, user convenience is improved. Also, the user can finish physical exercise at a point different from the point at which the user started running or walking. Consequently, the user can do physical exercise easily.

When the user does physical exercise such as running, the terminal apparatus 30 may execute an application program configured to support the physical exercise. The application program configured to support the physical exercise of the user may propose timing for finishing the physical exercise. The application program configured to support the physical exercise of the user may propose physical exercise suitable for the user or a duration of exercise suitable for the user. The terminal apparatus 30 may generate usage request information by acquiring information from the application program configured to support the physical exercise of the user.

The terminal apparatus 30 of the user may generate usage request information based on behavior information about the user such that the user can use the locker 60. As behavior information about the user, the terminal apparatus 30 may acquire product purchase history at a store. If the weight or size of purchased products becomes larger than a predetermined value, the terminal apparatus 30 may generate usage request information such that the user can use the locker 60 and output the usage request information to the server 10. This allows the user to use the locker 60 with appropriate timing without entering information. Consequently, user convenience is improved.

Monitoring

As illustrated in FIG. 3, the vehicle 20 may have a locker 60 provided with a monitoring unit 24. The monitoring unit 24 may monitor the locked state of the door or the open/closed state of the door of the locker 60. The monitoring unit 24 may include, for example, a sensor configured to detect opening/closing of the door of the locker 60. If it is detected that the door is open even though the locker 60 is in the locked state, the monitoring unit 24 may determine that there is an abnormality with the locker 60. If it is detected that the locker 60 is unlocked even though control information directed to unlocking the locker 60 has not been outputted, the monitoring unit 24 may determine that there is an abnormality with the locker 60. Upon determining that there is an abnormality with the locker 60, the monitoring unit 24 may output information notifying the abnormality with the locker 60 to the outside. The monitoring unit 24 may output, for example, information about the abnormality with the locker 60 to the server 10. To deal with the abnormality with the locker 60, the server controller 12 may start or stop the vehicle 20. The server controller 12 may output information directed to dispatching a service person who can deal with the abnormality with the locker 60 to the vehicle 20. The monitoring unit 24 may output information about the abnormality, for example, to the notification apparatus 23. The notification apparatus 23 may provide information about the abnormality with the locker 60 to the driver of the vehicle 20.

As illustrated in FIG. 3, the vehicle 20 may have the camera 24a as the monitoring unit 24 in the compartment 28. The server controller 12 may monitor the compartment 28 based on images taken by the camera 24a. The server controller 12 may monitor how the user behaves in the compartment 28 as well as the state of the locker 60 by analyzing the images taken by the camera 24a. By displaying the images taken by the camera 24a on a display device in order for an observer to view the images, the server controller 12 may enable the observer to monitor the interior of the compartment 28.

As illustrated in FIG. 3, the vehicle 20 may have a monitoring booth 24b as the monitoring unit 24 in the compartment 28. The observer staying in the monitoring booth 24b may monitor the interior of the compartment 28. The monitoring booth 24b may be substituted with a driver's seat. In that case, the driver of the vehicle 20 may monitor the interior of the compartment 28 as an observer.

As the vehicle 20 is provided with the monitoring unit 24, items can be stored in the locker 60 safely. Further, the user becomes less liable to experience trouble or become a victim of a crime. Consequently, user convenience is improved.

Configuration in which a User Storing an Item is Different from a User Retrieving the Item

A user storing an item in a locker 60 and a user retrieving the item from the locker 60 may be different from each other. That is, there may be a first user who stores an item in a locker 60 and a second user who retrieves the item from the locker 60. The server controller 12 may output first point-of-use information to the vehicle 20, the first point-of-use information concerning a first point of use at which the first user stores an item. The vehicle 20 may move to the first point of use based on the first point-of-use information. The server controller 12 may output second point-of-use information to the vehicle 20, the second point-of-use information concerning a second point of use at which second user retrieves an item after the first user stores the item in the locker 60. The vehicle 20 may move to the second point of use based on the second point-of-use information.

For example, the first user may be a home delivery person who delivers an item. The second user may be a recipient of the delivered item. The delivered item is also referred to as a delivery. In this case, the first user who is a home delivery person stores the delivery in an unoccupied partition of the locker 60. The server controller 12 may notify the terminal apparatus 30 of the second user who is the recipient of the delivery that the delivery has been stored. In response to the notification, the second user may enter the usage request information about the locker 60 in the terminal apparatus 30, retrieve the delivery from the locker 60, and thereby receive the delivery.

When plural first users store deliveries addressed to a second user in lockers 60, the server controller 12 may prepare a vehicle 20 such that each of the first users can store the deliveries in lockers 60 carried by the same vehicle 20. This allows the second user who is the recipient of the deliveries to receive all the deliveries together. Consequently, user convenience is improved.

One of the first and second users may be a service provider. The other of the first and second users may be a service receiver. For example, the first user and second user may be a rental service provider and a borrower, respectively. The first user and second user may be a customer who returns a borrowed item and a dealer who has the lent item which is being returned, respectively. For example, the first user and second user may be a cleaner who cleans clothes or the like and a customer who receives the cleaned item, respectively.

The first user may be a staff member of a store in which a user purchases a product. The second user may be the purchaser of the product. In this case, the product purchased by the user may be stored in the locker 60 by the staff member who is the first user, and retrieved by the purchaser who is the second user.

The first user and second user may have a relationship according to which an item is personally exchanged. The first user and second user may be, for example, family, friends, or acquaintances, or may be related via an SNS (Social Networking Service) or the like.

The first user and second user may have a business relationship. For example, a document may be exchanged between the first user and second user. In that case, the document may be stored in a locker 60 by the first user and retrieved from the locker 60 by the second user. Also, a tool used in business may be exchanged between the first user and second user.

As has been described above, the locker 60 may be used such that a user storing an item in the locker 60 and a user retrieving the item from the locker 60 will be different from each other. This improves user convenience.

### Example of an Operation Management Method

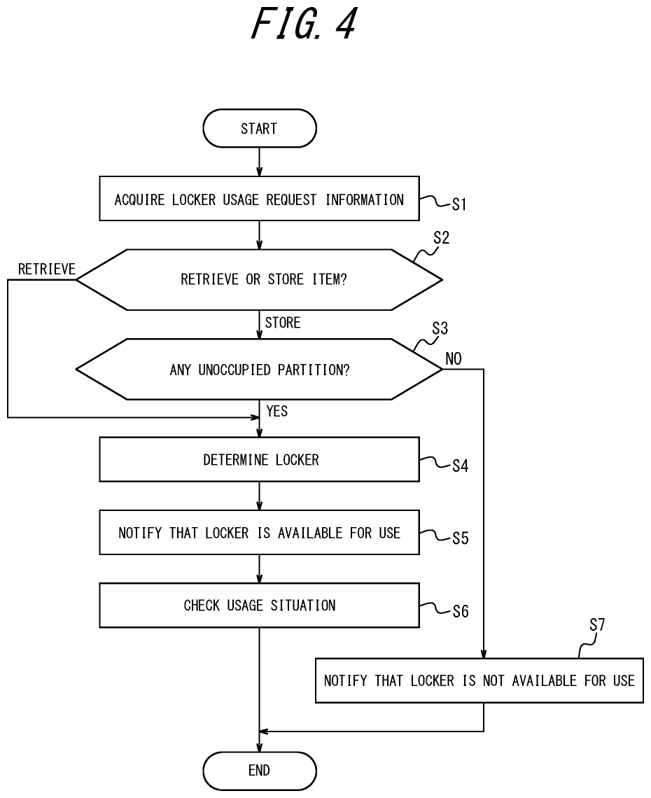

The server 10 included in the operation management system 1 may carry out an operation management method including procedures of the flowchart illustrated in FIG. 4 by example. The operation management method may be implemented as an operation management program to be executed by a processor such as the server controller 12. The operation management program may be stored in a non-transitory computer-readable medium.

The server controller 12 acquires usage request information from the terminal apparatus 30 of the user via the server communication interface 14 (step S1). The user can enter usage request information to request the use of the locker 60 by operating the terminal apparatus 30 possessed by the user. The terminal apparatus 30 outputs the usage request information entered by the user to the server 10. The terminal apparatus 30 enables the user to enter information indicating whether to store an item in the locker 60 or retrieve an item from the locker 60. The terminal apparatus 30 enables the user to specify the point of use. The terminal apparatus 30 may enable the user to specify the usage time. The terminal apparatus 30 may enable the user enter information about the item to be stored in the locker 60. The terminal apparatus 30 generates usage request information including the information entered by the user and outputs the usage request information to the server 10. The server controller 12 may register users as members in advance and store information about the users. The server controller 12 may accept requests for the use of lockers 60 only from the users registered as members. The server controller 12 may preferentially accept locker usage requests from the users registered as members.

Based on the usage request information, the server controller 12 determines whether the user's purpose for using the locker 60 is to store an item or to retrieve an item (step S2). When the user's purpose for using the locker 60 is to retrieve an item (step S2: retrieval), the server controller 12 proceeds to the procedure of step S4.

When the user's purpose for using the locker 60 is to store an item (step S2: storage), the server controller 12 determines whether there is an unoccupied partition in the locker 60 (step S3). The server controller 12 may check plural vehicles 20 to determine whether there is an unoccupied partition in the lockers 60. When there is an unoccupied partition in the locker 60 (step S3: YES), the server controller 12 proceeds to the procedure of step S4. When there is no unoccupied partition in the locker 60 (step S3: NO), the server controller 12 proceeds to the procedure of step S7.

When there is an unoccupied partition in the locker 60 (step S3: YES) or the user's purpose for using the locker 60 is to retrieve an item (step S2: retrieval), the server controller 12 determines the locker 60 that is to be used by the user (step S4). When the user's purpose for using the locker 60 is to retrieve an item, the server controller 12 determines the locker 60 storing the item as the locker 60 to be used by the user. When the user's purpose for use is to store an item, of the lockers 60 having unoccupied partitions, the server controller 12 determines a locker 60 that satisfies conditions contained in the usage request information as the locker 60 to be used by the user. The server controller 12 may select a vehicle 20 that satisfies the conditions specified by the usage request information, and determines the locker 60 carried by the selected vehicle 20 as the locker 60 to be used by the user. When the vehicle 20 carries two or more lockers 60, the server controller 12 may further select a locker 60 to be used by the user. The server controller 12 outputs control information including the point-of-use information based on usage request information to the vehicle 20 carrying the determined locker 60. Based on the control information, the vehicle 20 runs so as to arrive at the point of use at the usage time.

The server controller 12 notifies the user's terminal apparatus 30 that the locker 60 is available for use (step S5). The server controller 12 may additionally notify the terminal apparatus 30 about the point of use and the usage time.

The server controller 12 checks the usage status of the locker 60 (step S6). When the user stores an item in the locker 60, the server controller 12 recognizes the partition in which the item has been stored as an occupied partition. When the user retrieves an item from the locker 60, the server controller 12 recognizes the partition from which the item has been retrieved as an unoccupied partition. The server controller 12 may perform a billing process on the user just when the item is stored or retrieved. After the procedure of step S6, the server controller 12 finishes performing the procedures of the flowchart in FIG. 4.

When there are no unoccupied partitions in the locker 60 (step S3: NO), the server controller 12 notifies the user's terminal apparatus 30 that the locker 60 is not available for use (step S7). After the procedure of step S7, the server controller 12 finishes carrying out the procedures of the flowchart in FIG. 4.

As has been described above, when executed by the server controller 12 according to the present embodiment, the operation management method or the operation management program provides an on-demand locker service to the user. Consequently, convenience for the user using the locker 60 is improved.

Whereas an embodiment according to the present disclosure has been described based on drawings and examples, it should be noted that those skilled in the art can easily make various alterations and modifications based on the present disclosure. Thus, it should be noted that such alterations and modifications are included in the scope of the present disclosure. For example, functions and the like included in each means, step, or the like can be rearranged without any logical contradiction and plural means, steps, or the like can be combined into one or a means, step, or the like can be divided.

In the embodiment of the on-demand locker service that has been described above, the vehicle 20 acquires point-of-use information via the server 10 and moves based on the point-of-use information. The vehicle 20 may acquire the point-of-use information without involving the server 10. For example, through direct communication between the communication apparatus 22 and the user's terminal apparatus 30, the vehicle 20 may acquire usage request information directly from the terminal apparatus 30. In that case, the vehicle 20 may generate point-of-use information based on the usage request information using the control apparatus 21 and move to the point of use based on the point-of-use information. That is, the on-demand locker service can be provided without involving the server 10.

1. A vehicle comprising:
a compartment equipped with a locker configured to be usable by a user; and
a communication apparatus configured to communicably connect with a terminal apparatus possessed by the user and acquire point-of-use information from the terminal apparatus, the point-of-use information concerning a point at which the user uses the locker, wherein
the vehicle is configured to move based on the point-of-use information.

2. The vehicle according to claim 1, wherein a point to which the vehicle moves based on the point-of-use information when an item is retrieved from the locker by the user is different from a point at which the item is stored in the locker.

3. The vehicle according to claim 1, wherein:
the locker is configured to store an item having a size equal to or smaller than a predetermined size; and
when a size of an item to be stored in the locker by the user is equal to or smaller than the predetermined size, the vehicle moves based on the point-of-use information.

4. The vehicle according to claim 1, wherein:
the communication apparatus further acquires usage time information from the terminal apparatus, the usage time information specifying a time at which the user uses the locker; and
the vehicle moves based further on the usage time information.

5. The vehicle according to claim 1, wherein the compartment includes a private cubicle usable by the user.

6. The vehicle according to claim 1, further comprising a monitoring unit configured to monitor the compartment.

7. The vehicle according to claim 1, wherein:
a plurality of the users includes a first user and a second user;
the vehicle moves based on first point-of-use information about a first point of use at which the first user stores an item in the locker; and
after the first user stores the item in the locker; the vehicle moves based on second point-of-use information about a second point of use at which the second user retrieves the item from the locker.

8. The vehicle according to claim 1, wherein the point-of-use information is generated by and outputted from the terminal apparatus based on information entered in the terminal apparatus by the user.

9. The vehicle according to claim 1, wherein the point-of-use information is generated by and outputted from the terminal apparatus based on a status of the user.

10. The vehicle according to claim 1, further comprising a control apparatus configured to control running of the vehicle based on the point-of-use information.

11. The vehicle according to claim 1, further comprising a notification apparatus configured to provide the point-of-use information to a driver; wherein
the vehicle moves by being operated by the driver based on the point-of-use information.

12. An operation management system comprising: the vehicle according to claim 1; and the terminal apparatus possessed by the user, wherein
the terminal apparatus outputs the point-of-use information.

13. The operation management system according to claim 12, wherein the terminal apparatus generates and outputs the point-of-use information based on information entered in the terminal apparatus by the user.

14. The operation management system according to claim 12, wherein the terminal apparatus generates and outputs the point-of-use information based on a status of the user.

15. An operation management method comprising steps in which:
a vehicle carrying a locker usable by a user and configured to be movable acquires point-of-use information about a point at which the user uses the locker; and
the vehicle moves based on the point-of-use information.

16. The operation management method according to claim 15, further comprising a step in which a terminal apparatus possessed by the user generates the point-of-use information based on information entered by the user.

17. The operation management method according to claim 15, further comprising a step in which a terminal apparatus possessed by the user generates the point-of-use information based on a status of the user.

18. An information processing apparatus comprising:
a communication interface configured to communicably connect with a vehicle and with a terminal apparatus possessed by a user, the vehicle carrying a locker configured to be usable by the user; and
a controller configured to output control information used to control running of the vehicle,
wherein the communication interface is configured to acquire point-of-use information from the terminal apparatus, the point-of-use information concerning a point at which the user uses the locker, and
the controller is configured to generate the control information based on the point-of-use information and outputs the control information to the vehicle through the communication interface.

19. The information processing apparatus according to claim 18, wherein the point-of-use information is generated by and outputted from the terminal apparatus based on information entered in the terminal apparatus by the user.

20. The information processing apparatus according to claim 18, wherein the point-of-use information is generated by and outputted from the terminal apparatus based on a status of the user.
